(19) United States
(12) Patent Application Publication
(10) Pub. No.: US 2022/0178616 A1
(43) Pub. Date: Jun. 9, 2022

(54) LIGHT BLOCKING FILM FOR USE WITH A CAMERA ASSEMBLY IN AN OVEN APPLIANCE

(71) Applicant: Haier US Appliance Solutions, Inc., Wilmington, DE (US)

(72) Inventor: Eugenio Gomez, Louisville, KY (US)

(21) Appl. No.: 17/110,959

(22) Filed: Dec. 3, 2020

(51) Int. Cl. F27D 21/02; G02F 1/1334; G02F 1/137; G02F 1/1685; G02B 26/02; F27D 19/00; F24C 15/04; H04N 7/18; H04N 5/225; H04N 5/232

(52) U.S. Cl. CPC F27D 21/02; G02F 1/1334; G02F 1/137; G02F 1/1685; G02B 26/02; F27D 2021/026; F24C 15/04; H04N 7/183; H04N 5/2253; H04N 5/23203; F27D 19/00

(57) ABSTRACT

An oven appliance includes a cooking chamber positioned within a cabinet and a door rotatably mounted to the cabinet for providing selective access to the cooking chamber, the door comprising a window. A camera assembly is positioned within the door and a light blocking film configured for selectively blocking light from entering the cooking chamber through the window. Images obtained by the camera assembly are displayed on an appliance display or a remote application (e.g., via mobile phone) and the light blocking film is activated prior to obtaining the images to prevent light from passing through the window and creating undesirable reflections.

### FIELD OF THE INVENTION

The present subject matter relates generally to oven appliances, and more particularly, to door and camera assemblies for oven appliances.

### BACKGROUND OF THE INVENTION

Conventional residential and commercial oven appliances generally include a cabinet that includes a cooking chamber for receipt of food items for cooking. Multiple heating elements are positioned within the cooking chamber to provide heat to food items located therein. The heating elements can include, for example, radiant heating elements, such as a bake heating assembly positioned at a bottom of the cooking chamber and/or a separate broiler heating assembly positioned at a top of the cooking chamber.

Conventional oven appliances include a door that provides selective access to the cooking chamber and typically includes a window to permit a user to view a cooking process. Notably, it may also be desirable to use a camera to generate images of food during a cooking process, e.g., to facilitate monitoring of the cooking progress via a display or a remote device, such as a mobile phone. However, ambient light within the kitchen often shines through the window into the cooking chamber and such light can generate undesirable reflections that affect the image quality obtained by the camera. As a result, it is difficult to have a single oven appliance that permits a window for viewing the cooking chamber and a camera assembly for obtaining images of the cooking chamber without obtaining poor quality images from the camera assembly.

Accordingly, an oven appliance that includes an improved camera assembly would be useful. More particularly, an oven appliance with a camera assembly that is capable of providing high-quality, reflection-free images would be particularly beneficial.

### BRIEF DESCRIPTION OF THE INVENTION

Aspects and advantages of the invention will be set forth in part in the following description, or may be apparent from the description, or may be learned through practice of the invention.

In one exemplary embodiment, an oven appliance defining a vertical, a lateral, and a transverse direction is provided. The oven appliance includes a cooking chamber positioned within a cabinet, a door rotatably mounted to the cabinet for providing selective access to the cooking chamber, the door comprising a window, a camera assembly configured for obtaining one or more images of the cooking chamber, and a light blocking film configured for selectively blocking light from entering the cooking chamber through the window.

In another exemplary embodiment, a method of operating an oven appliance is provided. The oven appliance includes a cooking chamber, a door providing selective access to the cooking chamber and comprising a window, a camera assembly for monitoring the cooking chamber, and a light blocking film for selectively blocking light from passing through the window into the cooking chamber. The method includes receiving a command to obtain one or more images of the cooking chamber, activating the light blocking film by applying a voltage to transition the light blocking film from transparent to opaque, and operating the camera assembly to obtain the one or more images after the light blocking film has been activated.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 is a front view of an oven appliance according to an exemplary embodiment of the present subject matter.

FIG. 2 is a perspective, cross-sectional view of the exemplary oven appliance of FIG. 1, taken along Line 2-2 in FIG. 1.

FIG. 3 is a side, cross-sectional view of the exemplary oven appliance of FIG. 1, taken along Line 2-2 in FIG. 1.

FIG. 4 provides a schematic side for of a door, camera, and light blocking film that may be used with the exemplary oven appliance of FIG. 1 according to an exemplary embodiment of the present subject matter.

FIG. 5 provides a method of operating a camera assembly of an oven appliance according to an exemplary embodiment of the present subject matter.

Repeat use of reference characters in the present specification and drawings is intended to represent the same or analogous features or elements of the present invention.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first,” “second,” and “third” may be used interchangeably to distinguish one component from another and are not intended to signify location or importance of the individual components. The terms “upstream” and “downstream” refer to the relative flow direction with respect to fluid flow in a fluid pathway. For example, “upstream” refers to the flow direction from which the fluid flows, and “downstream” refers to the flow direction to which the fluid flows. The terms “includes” and “including” are intended to be inclusive in a manner similar to the term “comprising.” Similarly, the term “or” is generally intended to be inclusive (i.e., “A or B” is intended to mean “A or B or both”).

Approximating language, as used herein throughout the specification and claims, is applied to modify any quantitative representation that could permissibly vary without resulting in a change in the basic function to which it is related. Accordingly, a value modified by a term or terms, such as “about,” “approximately,” and “substantially,” are not to be limited to the precise value specified. In at least some instances, the approximating language may correspond to the precision of an instrument for measuring the value. For example, the approximating language may refer to being within a 10 percent margin.

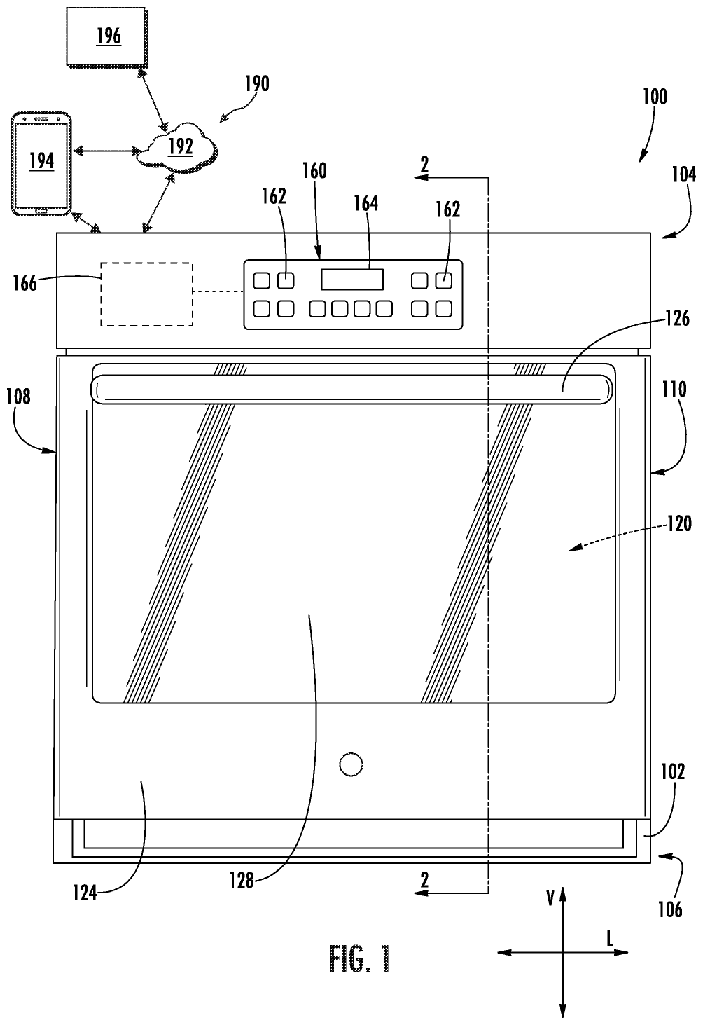

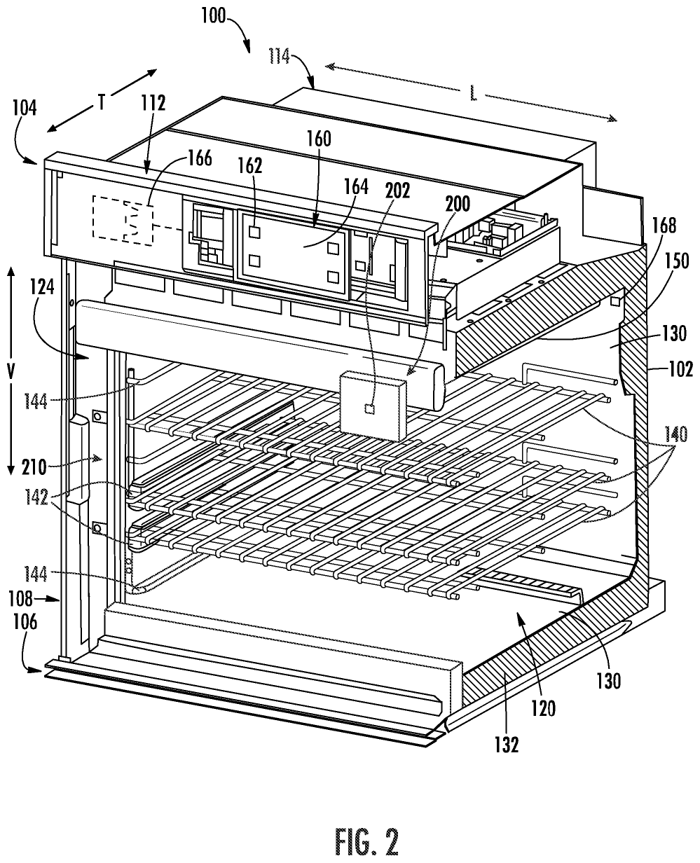

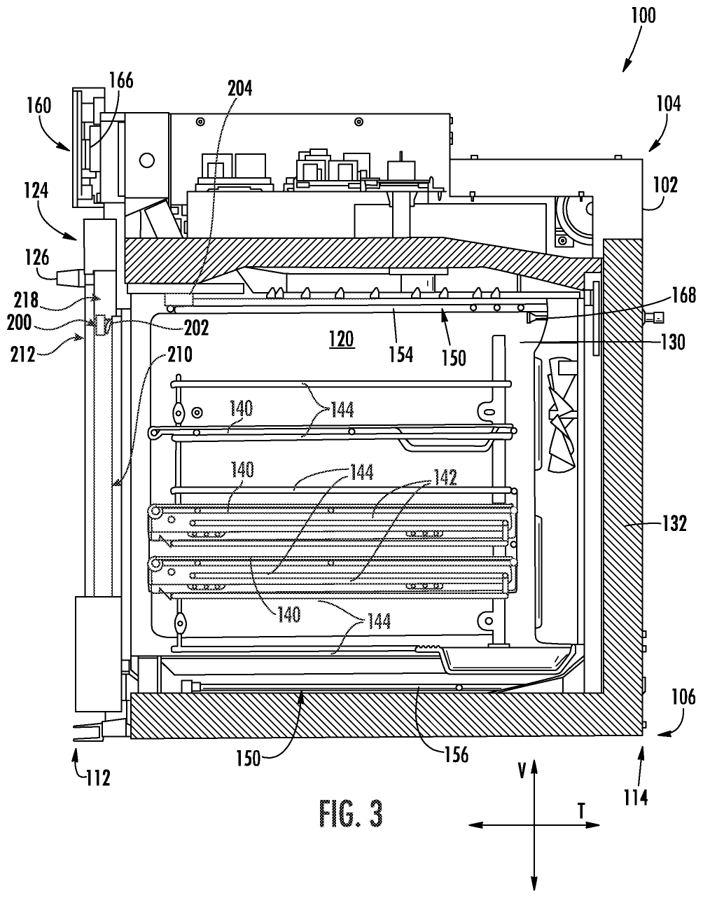

FIG. 1 provides a front view of an oven appliance 100 as may be employed with the present subject matter. In addition, FIGS. 2 and 3 provide perspective and side cross-sectional views, respectively, of oven appliance 100. As shown, oven appliance 100 generally defines a vertical direction V, a lateral direction L, and a transverse direction T, each of which is mutually perpendicular, such that an orthogonal coordinate system is generally defined. As illustrated, oven appliance 100 includes an insulated cabinet 102. Cabinet 102 of oven appliance 100 extends between a top 104 and a bottom 106 along the vertical direction V, between a first side 108 (left side when viewed from front) and a second side 110 (right side when viewed from front) along the lateral direction L, and between a front 112 and a rear 114 along the transverse direction T.

Within cabinet 102 is a single cooking chamber 120 which is configured for the receipt of one or more food items to be cooked. However, it should be appreciated that oven appliance 100 is provided by way of example only, and aspects of the present subject matter may be used in any suitable cooking appliance, such as a gas or electric double oven range appliance. For example, although oven appliance 100 is illustrated as a wall oven installed within a bank of cabinets, it should be appreciated that aspects of the present subject matter may be used in free-standing oven appliances, double ovens, etc. Moreover, aspects of the present subject matter may be used in any other consumer or commercial appliance where it is desirable to use a camera within another suitable appliance. Thus, the example embodiment shown in FIGS. 1 through 3 is not intended to limit the present subject matter to any particular cooking chamber configuration or arrangement.

Oven appliance 100 includes a door 124 rotatably attached to cabinet 102 in order to permit selective access to cooking chamber 120. Handle 126 is mounted to door 124 to assist a user with opening and closing door 124 in order to access cooking chamber 120. As an example, a user can pull on handle 126 mounted to door 124 to open or close door 124 and access cooking chamber 120. One or more transparent viewing windows 128 (FIG. 1) may be defined within door 124 to provide for viewing the contents of cooking chamber 120 when door 124 is closed and also assist with insulating cooking chamber 120. According to alternative embodiments, windows 128 may be omitted from door 124 altogether, while cavity visibility may be maintained using a camera system, e.g., as described herein.

In general, cooking chamber 120 is defined by a plurality of chamber walls 130 (FIGS. 2 and 3). Specifically, cooking chamber 120 may be defined by a top wall, a rear wall, a bottom wall, and two sidewalls 130. These chamber walls 130 may be joined together to define an opening through which a user may selectively access cooking chamber 120 by opening door 124. In order to insulate cooking chamber 120, oven appliance 100 includes an insulating gap defined between the chamber walls 130 and cabinet 102. According to an exemplary embodiment, the insulation gap is filled with an insulating material 132, such as insulating foam or fiberglass, for insulating cooking chamber 120.

Referring now to FIG. 3, oven appliance 100 may include a plurality of racks 140 positioned within cooking chamber 120 for receiving food or cooking utensils containing food items. Racks 140 provide support for such food during a cooking process. According to the illustrated embodiment, racks 140 may be slidably mounted within cooking chamber 120 by one or more slide assemblies 142 that are mounted to a sidewall 130 of cooking chamber 120. Alternatively, racks 140 may be slidably received onto embossed ribs or sliding rails such that racks 140 may be conveniently moved into and out of cooking chamber 120.

As best shown in FIG. 3, oven appliance may include six rack supports 144 that are spaced apart along the vertical direction V. In addition, oven appliance 100 is illustrated as including three racks 140 that may each be slidably positioned on each of the six rack supports 128, such that six total rack positions are possible within cooking chamber 120. However, it should be appreciated that according to alternative embodiments, any suitable number of racks mounted in cooking chamber 120 in any suitable manner and being movable between any suitable number of positions is possible and within the scope of the present subject matter.

Oven appliance may further include one or more heating elements (identified generally by reference numeral 150) positioned within cabinet 102 or may otherwise be in thermal communication with cooking chamber 120 for regulating the temperature within cooking chamber 120. For example, heating elements 150 may be electric resistance heating elements, gas burners, microwave heating elements, halogen heating elements, or suitable combinations thereof. According to an exemplary embodiment, oven appliance 100 is a self-cleaning oven. In this regard, heating elements 150 may be configured for heating cooking chamber 120 to a very high temperature (e.g., 800° F. or higher) in order to burn off any food residue or otherwise clean cooking chamber 120.

Specifically, an upper gas or electric heating element 154 (also referred to as a broil heating element or gas burner) may be positioned in cabinet 102, e.g., at a top portion of cooking chamber 120, and a lower gas or electric heating element 156 (also referred to as a bake heating element or gas burner) may be positioned at a bottom portion of cooking chamber 120. Upper heating element 154 and lower heating element 156 may be used independently or simultaneously to heat cooking chamber 120, perform a baking or broil operation, perform a cleaning cycle, etc. The size and heat output of heating elements 154, 156 can be selected based on the, e.g., the size of oven appliance 100 or the desired heat output. Oven appliance 100 may include any other suitable number, type, and configuration of heating elements 150 within cabinet 102. For example, oven appliance 100 may further include electric heating elements, induction heating elements, or any other suitable heat generating device.

A user interface panel 160 is located within convenient reach of a user of the oven appliance 100. For this example embodiment, user interface panel 160 includes user inputs 162 that may generally be configured for regulating heating elements 150 or operation of oven appliance 100. In this manner, user inputs 162 allow the user to activate each heating element 150 and determine the amount of heat input provided by each heating element 150 to a cooking food items within cooking chamber 120. Although shown with user inputs 162, it should be understood that user inputs 162 and the configuration of oven appliance 100 shown in FIG. 1 is provided by way of example only. More specifically, user interface panel 160 may include various input components, such as one or more of a variety of touch-type controls, electrical, mechanical or electro-mechanical input devices including rotary dials, push buttons, and touch pads. User interface panel 160 may also be provided with one or more graphical display devices or display components 164, such as a digital or analog display device designed to provide operational feedback or other information to the user such as e.g., whether a particular heating element 150 is activated and/or the rate at which the heating element 150 is set.

Generally, oven appliance 100 may include a controller 166 in operative communication with user interface panel 160. User interface panel 160 of oven appliance 100 may be in communication with controller 166 via, for example, one or more signal lines or shared communication busses, and signals generated in controller 166 operate oven appliance 100 in response to user input via user inputs 162. Input/Output (“I/O”) signals may be routed between controller 166 and various operational components of oven appliance 100 such that operation of oven appliance 100 can be regulated by controller 166. In addition, controller 166 may also be communication with one or more sensors, such as temperature sensor 168 (FIG. 2), which may be used to measure temperature inside cooking chamber 120 and provide such measurements to the controller 166. Although temperature sensor 168 is illustrated at a top and rear of cooking chamber 120, it should be appreciated that other sensor types, positions, and configurations may be used according to alternative embodiments.

Controller 166 is a “processing device” or “controller” and may be embodied as described herein. Controller 166 may include a memory and one or more microprocessors, microcontrollers, application-specific integrated circuits (ASICS), CPUs or the like, such as general or special purpose microprocessors operable to execute programming instructions or micro-control code associated with operation of oven appliance 100, and controller 166 is not restricted necessarily to a single element. The memory may represent random access memory such as DRAM, or read only memory such as ROM, electrically erasable, programmable read only memory (EEPROM), or FLASH. In one embodiment, the processor executes programming instructions stored in memory. The memory may be a separate component from the processor or may be included onboard within the processor. Alternatively, controller 166 may be constructed without using a microprocessor, e.g., using a combination of discrete analog and/or digital logic circuitry (such as switches, amplifiers, integrators, comparators, flip-flops, AND gates, and the like) to perform control functionality instead of relying upon software.

Referring still to FIG. 1, a schematic diagram of an external communication system 190 will be described according to an exemplary embodiment of the present subject matter. In general, external communication system 190 is configured for permitting interaction, data transfer, and other communications between and among oven appliance 100 and/or a user of oven appliance 100. For example, this communication may be used to provide and receive operating parameters, cycle settings, performance characteristics, user preferences, or any other suitable information for improved performance of oven appliance 100. In addition, according to aspects of the present subject matter, external communication system 190 may be used to transfer images or video to a user of oven appliance 100, as described in more detail below.

External communication system 190 permits controller 166 of oven appliance 100 to communicate with external devices either directly or through a network 192. For example, a consumer may use a consumer device 194 to communicate directly with oven appliance 100. Alternatively, these appliances may include user interfaces for receiving such input (described below). For example, consumer devices 194 may be in direct or indirect communication with oven appliance 100, e.g., directly through a local area network (LAN), Wi-Fi, Bluetooth, Zigbee, etc. or indirectly through network 192. In general, consumer device 194 may be any suitable device for providing and/or receiving communications, displaying images or video, or receiving commands from a user. In this regard, consumer device 194 may include, for example, a personal phone, a tablet, a laptop computer, or another mobile device.

In addition, a remote server 196 may be in communication with oven appliance 100 and/or consumer device 194 through network 192. In this regard, for example, remote server 196 may be a cloud-based server 196, and is thus located at a distant location, such as in a separate state, country, etc. In general, communication between the remote server 196 and the client devices may be carried via a network interface using any type of wireless connection, using a variety of communication protocols (e.g. TCP/IP, HTTP, SMTP, FTP), encodings or formats (e.g. HTML, XML), and/or protection schemes (e.g. VPN, secure HTTP, SSL).

In general, network 192 can be any type of communication network. For example, network 192 can include one or more of a wireless network, a wired network, a personal area network, a local area network, a wide area network, the internet, a cellular network, etc. According to an exemplary embodiment, consumer device 194 may communicate with a remote server 196 over network 192, such as the internet, to provide user inputs, transfer operating parameters or performance characteristics, cycle authorizations, display images or video, etc. In addition, consumer device 194 and remote server 196 may communicate with oven appliance 100 to communicate similar information.

External communication system 190 is described herein according to an exemplary embodiment of the present subject matter. However, it should be appreciated that the exemplary functions and configurations of external communication system 190 provided herein are used only as examples to facilitate description of aspects of the present subject matter. System configurations may vary, other communication devices may be used to communicate directly or indirectly with one or more oven or cooking appliances, other communication protocols and steps may be implemented, etc. These variations and modifications are contemplated as within the scope of the present subject matter.

Referring now to FIGS. 2 through 4, door 124 and a camera assembly 200 will be described in more detail according to exemplary embodiments of the present subject matter. More specifically, according to exemplary embodiments, oven appliance 100 may include a camera assembly 200 which is positioned within door 124 and is generally configured for providing images of food items that are cooking within cooking chamber 120. In this regard, for example, camera assembly 200 includes a camera 202 that is configured for taking still images or video and transmitting those images to a user to provide feedback regarding the cooking process. According to still other embodiments, camera 202 may be a thermal imaging device or any other device for providing the user with feedback regarding the food items being cooked within cooking chamber 120.

Oven appliance 100 may obtain, transmit, and display one or more images or live video from within cooking chamber 120. For example, camera 202 can provide a live image or video to display 164 (FIG. 1) upon user request. According to still other embodiments, images obtained by camera assembly 200 may be transmitted to a user via a remote device 194. It should be appreciated that the images obtained by camera assembly 200 may vary in number, frequency, angle, resolution, detail, etc. For example, aspects of the present subject matter may be performed using a single image. By contrast, aspects of the present subject matter may also be performed using a plurality of images taken from different angles, at different times or frequencies. Moreover, camera assembly 200 may obtain one or more video clips, a live stream, or any suitable combination thereof for transmission to a display visible to the user. In addition, according to exemplary embodiments, controller 166 may be configured for illuminating cooking chamber 120 just prior to obtaining the one or more images, e.g., using a chamber light 204 or a light positioned on camera assembly 200.

According to the illustrated embodiment, camera assembly 200 is installed in a fixed location within an oven appliance 100 such that it is in view of substantially the entire cooking chamber 120. Although the present embodiment illustrates a stationary camera assembly 200, it should be appreciated that according to alternative embodiments, camera assembly 200 may be adjustable while remaining within the scope of the present subject matter. In addition, as will be described in more detail below, camera assembly 200 is mounted within door 124 of oven appliance 100. However, it should be appreciated that camera assembly 200 may be mounted at any other suitable location within oven appliance 100 while remaining within scope the present subject matter.

As best shown in FIGS. 2 through 4, door 124 generally includes an inner door panel 210 positioned proximate cooking chamber 120 and an outer door panel 212 positioned proximate an ambient environment (e.g., outside of oven appliance 100). In general, each of inner door panel 210 and outer door panel 212 may include one or more transparent windows (such as window 128). Although these windows are referred to herein as glass panes, it should be appreciated that these transparent windows may be constructed of any suitably rigid and temperature resistant material, e.g., such as acrylic glass or Plexiglass. Although door 124 is described in here as having two or more transparent panels 210, 212, it should be appreciated that according to alternative embodiments, door 124 may include fewer than or more than two panels formed from any suitable transparent material.

Specifically, according to the illustrated embodiment, inner door panel 210 includes an inner glass pane 214 (which is closest to or faces cooking chamber 120) and outer door panel 212 includes an outer glass pane 216. A spacer bracket 218 is positioned between inner glass pane 214 and outer glass pane 216 to maintain a gap between the two glass panes. Specifically, inner glass pane 214 and outer glass pane 216 are separated by an air gap 220 along the transverse direction T (e.g., when door 124 is closed). In general, air gap 220 defines helps insulate cooking chamber 120. Although inner door panel 210 and outer door panel 212 are illustrated herein as having single glass panes, it should be appreciated that each assembly may include multiple glass panes or any other suitable construction according to alternative embodiments. For example, door panels 210, 212 may include any suitable number of transparent windows formed from any suitable material may be used according to alternative embodiments.

Referring still to FIGS. 2 through 4, camera assembly 200 is mounted within door 124 according to exemplary embodiments of the present subject matter. Specifically, camera assembly 200 is mounted between inner door panel 210 and outer door panel 212. However, it should be appreciated that according to alternative embodiments, camera assembly 200 may be positioned elsewhere within cabinet 102, such as along a sidewall 130 of cooking chamber 120. Notably, it is typically desirable that inner glass pane 214 and outer glass pane 216 of door 124 be transparent such that a user may directly view inside cooking chamber 120. However, as noted briefly above, oven appliance 100 may further be configured for transmitting the images obtained by camera assembly 200 to the user via a display, such as display 164 or a remote device 194. Notably, however, light that passes from within the room, through door 124, and into cooking chamber 120 may generate undesirable reflections that are picked up by camera assembly 200 and result in image distortion or degraded quality.

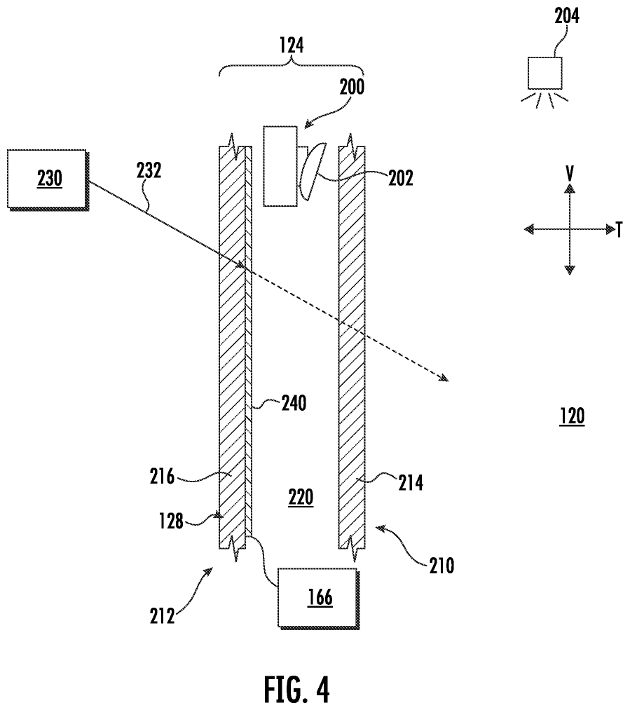

Specifically, as shown schematically in FIG. 4, an ambient light source 230 may generate light 232, that if unobstructed, may pass directly into cooking chamber 120 through door 124. In this regard, the solid line illustrates light 232 when the door is opaque while the dotted line portion of 232 illustrates the transmission of light when the door is transparent. When door 124 is transparent, resulting light 232 within cooking chamber 120 generates reflections or distortions which may be eliminated by making door 124 a solid, opaque structure. However, an opaque door 124 would prevent user visibility through door 124 into cooking chamber 120. Aspects of the present subject matter are directed to films or other materials that may transition between two states that either permit or block the transmission of light. Specifically, according to the illustrated embodiment, oven appliance 100 may include a light blocking film 240 that is operably coupled to controller 166 for selectively blocking, distorting, or dispersing light 232 as it passes through door 124. In this regard, referring still to FIG. 4, light blocking film 240 is illustrated in an opaque state, such that light 242 prevented from entering cooking chamber 120.

In general, light blocking film 240 may be positioned at any suitable location for preventing light 232 from distorting or otherwise causing reflections in images obtained by camera assembly 200. In this regard, for example, light blocking film 240 may be positioned on outer glass pane 216 of door 124 such that camera assembly 200 is positioned between cooking chamber 120 and light blocking film 240 along the transverse direction T. More specifically, as illustrated, light blocking film 240 is positioned within air gap 220 and is seated against an internal surface of outer glass pane 216.

According to exemplary embodiments, light blocking film 240 may be any size or geometry suitable for blocking a sufficient amount of light reflections to obtain desirable images using camera assembly 200. For example, according to exemplary embodiments, light blocking film 240 may cover a small area of the window, e.g., just enough to surround camera 202, e.g., such as between about 5% and 50%, between about 10% and 40%, between about 20% and 30%, or about 25%. According to still other exemplary embodiments, light blocking film 240 may cover a broader area, e.g., such as greater than 50% of a surface area of outer glass pane 216. According still other embodiments, light blocking film may cover greater than 70%, greater than 90%, or may cover the entirety of the surface area of outer glass pane 216. It should be appreciated that light blocking film 240 may be applied or attached to door 124 using any suitable device or mechanisms. In addition, variations to the number, size, configuration, and operation of light blocking film 240 may be used while remaining within the scope of the present subject matter.

It should be appreciated that light blocking film 240 may be any suitable material, film, or component that may transition between one or more states, where one state permits some or all of light 232 to pass through door 124, while the other state prevents at least a portion of light 232 from passing through door 124 to minimize reflections obtained by camera 202. In other words, light blocking film 240 may generally be any suitable film or coating technology that is configured for transitioning between a transparent or semi-transparent material (referred to herein as the “transparent” state) to an opaque, translucent, or non-transparent material (referred to herein as the “opaque” state). According to exemplary embodiments, this transition between the transparent and opaque state may be initiated by controller 166, e.g., by applying a voltage to light blocking film 240. However, it should be appreciated that any other suitable initiation action could be used while remaining within the scope of the present subject matter.

According to exemplary embodiments, the light blocking film 240 may implement a liquid crystal technology, such as polymer dispersed liquid crystal (PDLC) technology. These technologies typically rely on the alignment of liquid crystal molecules within a polymer matrix either being aligned or randomly oriented. When the molecules are randomly oriented, these molecules tend to block the passage of light through the liquid crystal film (e.g., such that the film is substantially opaque). By contrast, when the molecules are aligned, light is permitted to shine directly through the film (e.g., such that it appears substantially transparent). Typically, these liquid crystal films use an electric voltage to transition the film between the transparent and opaque states. These liquid crystal films may include dissolved liquid crystals that are hardened or formed on polymer or glass such that they are dispersed throughout the glass or film sheet. These liquid crystals scatter the light and make the glass or film appear opaque until electricity is appliance, which causes the liquid crystals to align and allow light to pass through.

According to alternative exemplary embodiments, the light blocking film 240 may utilize suspended particle devices for implementing the transition between opaque and transparent states. Suspended particle devices may operate similar to liquid crystal technologies, by having particles suspended between multiple glass or polymer panes that selectively permit light therethrough. Specifically, the glass panes may include a conductive coating that can be used to provide an electric charge to the suspended particles. These particles are aligned within a liquid suspension when electricity is applied through the conductive coating, allowing light to flow therethrough.

According to still other embodiments, the light blocking film 240 implement micro-blind technology. In this regard, for example, micro-blinds may be very small electrodes (e.g., invisible to the eye) that curl when exposed to electrostatic forces. For example, micro-blinds may include multiple layers of glass that defines a space therebetween that includes a coating that changes transparency to provide shading when activated. According to exemplary embodiments, micro-blinds include thin, rolled metal blinds that are positioned within or on top of glass and which can be controlled with electricity. Specifically, when no voltage is applied, the metal pieces are rolled such that light can pass through. By contrast, when electricity is applied, an electric field forms between the glass and the metal blinds that makes the metal blinds unroll and flatten out to block the light.

Although exemplary materials are described herein for use in transitioning windows of oven door between transparent and opaque, it should be appreciated that these are only a few exemplary technologies that may be employed. Other technologies and materials are possible, different means for transitioning those materials between states may be used, and other variations may be employed while remaining within the scope of the present subject matter. In addition, the size, position, and orientation of light blocking film 240 may vary while remaining within the scope of the present subject matter. Indeed, any suitable use of a film that can be transitioned to selectively block light and/or reflections for improved imaging by a camera assembly may be used while remaining within the scope of the present subject matter.

Now that the construction of oven appliance 100, camera assembly 200, in light blocking film 240 have been described according to exemplary embodiments, an exemplary method 300 of operating a camera assembly along with a light blocking film to obtain reflection free images of a cooking chamber within an oven appliance will be described. Although the discussion below refers to the exemplary method 300 of operating camera assembly 200 of oven appliance 100, one skilled in the art will appreciate that the exemplary method 300 is applicable to the operation of a variety of other appliances, camera systems, and light blocking films.

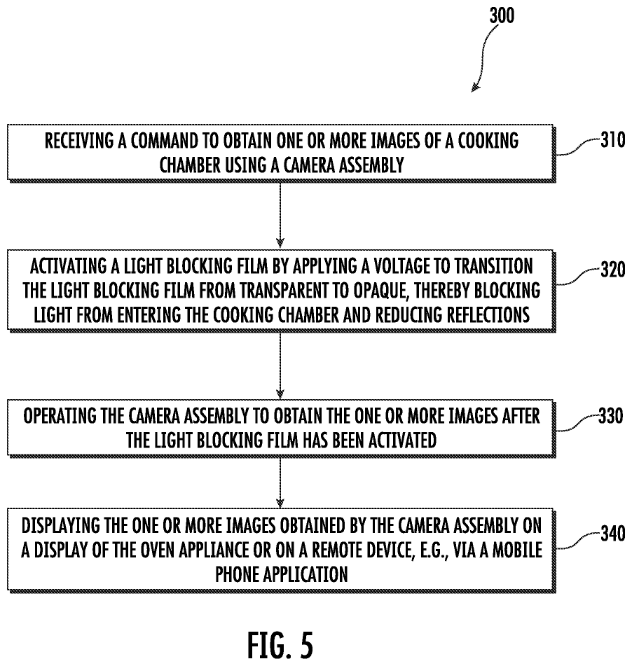

Referring now to FIG. 5, method 300 includes, at step 310, receiving a command to obtain one or more images of a cooking chamber using a camera assembly. In this regard, continuing the example from above, a user may wish to view cooking operations within cooking chamber 120 using display 164 or a remote device 194. As such, the user may request and/or controller 166 may display images obtained by camera assembly 200 on either or both display 164 and remote device 194. Notably, as explained above, images obtained by camera assembly 200 may have light reflections or distortions resulting from light 232 that passes through a transparent glass panes 214, 216. As such, step 320 may include activating a light blocking film by applying a voltage to transition the light blocking film from transparent to opaque, thereby blocking light from entering the cooking chamber and reducing reflections. In this regard, when controller 166 receives a request to obtain images with camera assembly 200, controller 166 may first activate light blocking film 240, e.g., by applying a voltage to light blocking film 240. As a result, some or all of light 232 will be prevented from entering cooking chamber 120, thereby resulting in an improved imaging process.

Step 330 may then include operating the camera assembly to obtain the one or more images after the light blocking film has been activated. Step 340 may include displaying the one or more images obtained by camera assembly on a display of the oven appliance or on a remote device, e.g., via mobile phone application. Thus, after light blocking film 240 has been activated to reduce reflections and prevent distortion, camera assembly 200 may obtain and transmit images or video of cooking chamber 120 to a user in any suitable manner. After the images are obtained, controller may deactivate light blocking film 240 e.g., by removing the applied voltage, thereby permitting a user to directly view cooking chamber 120 through glass panes 214, 216.

FIG. 5 depicts steps performed in a particular order for purposes of illustration and discussion. Those of ordinary skill in the art, using the disclosures provided herein, will understand that the steps of any of the methods discussed herein can be adapted, rearranged, expanded, omitted, or modified in various ways without deviating from the scope of the present disclosure. Moreover, although aspects of method 300 are explained using oven appliance 100, camera assembly 200, and light blocking film 240 as an example, it should be appreciated that these methods may be applied to the operation of any oven appliance or camera system having any other suitable configuration or light blocking technology.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. An oven appliance defining a vertical, a lateral, and a transverse direction, the oven appliance comprising:
a cooking chamber positioned within a cabinet;
a door rotatably mounted to the cabinet for providing selective access to the cooking chamber, the door comprising a window;
a camera assembly configured for obtaining one or more images of the cooking chamber; and
a light blocking film configured for selectively blocking light from entering the cooking chamber through the window.

2. The oven appliance of claim 1, wherein the camera assembly is positioned between the cooking chamber and the light blocking film along the transverse direction.

3. The oven appliance of claim 1, wherein the camera assembly is mounted to the door.

4. The oven appliance of claim 1, wherein the door comprises an inner window and an outer window separated by an airgap, wherein the camera assembly is positioned within the airgap.

5. The oven appliance of claim 4, wherein the light blocking film is mounted to the outer window inside the airgap.

6. The oven appliance of claim 1, wherein the light blocking film transitions between transparent and opaque or semi-transparent.

7. The oven appliance of claim 1, wherein the light blocking film comprises polymer dispersed liquid crystal.

8. The oven appliance of claim 1, wherein the light blocking film comprises suspended particle devices.

9. The oven appliance of claim 1, wherein the light blocking film comprises micro-blinds.

10. The oven appliance of claim 1, wherein the light blocking film covers between about 20% and 25% of a surface area of the window.

11. The oven appliance of claim 1, wherein the light blocking film covers greater than 50% of a surface area of the window.

12. The oven appliance of claim 1, further comprising a controller that is operably coupled to the light blocking film, wherein the controller is configured to:
receive a command to activate the light blocking film; and
apply a voltage to the light blocking film to activate the light blocking film.

13. The oven appliance of claim 1, further comprising a controller in operative communication with the camera assembly and the light blocking film, the controller being configured to:
receive a command to obtain the one or more images of the cooking chamber;
activate the light blocking film; and
operate the camera assembly to obtain the one or more images after the light blocking film has been activated.

14. The oven appliance of claim 1, further comprising:
a display for displaying the one or more images obtained by the camera assembly.

15. The oven appliance of claim 1, further comprising:
a controller in operative communication with a remote device, the controller being configured to display the one or more images obtained by the camera assembly on the remote device.

16. A method of operating an oven appliance, the oven appliance comprising a cooking chamber, a door providing selective access to the cooking chamber and comprising a window, a camera assembly for monitoring the cooking chamber, and a light blocking film for selectively blocking light from passing through the window into the cooking chamber, the method comprising:
receiving a command to obtain one or more images of the cooking chamber;
activating the light blocking film by applying a voltage to transition the light blocking film from transparent to opaque; and
operating the camera assembly to obtain the one or more images after the light blocking film has been activated.

17. The method of claim 16, wherein the door comprises an inner window and an outer window separated by an airgap, wherein the camera assembly is positioned within the airgap, and wherein the light blocking film is mounted to the outer window inside the airgap.

18. The method of claim 16, wherein the light blocking film comprises at least one of polymer dispersed liquid crystal, suspended particle devices, or micro-blinds.

19. The method of claim 16, wherein the oven appliance is communicatively coupled with a remote device, the method further comprising:
displaying the one or more images obtained by the camera assembly on the remote device.

20. The method of claim 16, wherein the oven appliance further comprises a display for displaying the one or more images obtained by the camera assembly, the method further comprising:
displaying the one or more images obtained by the camera assembly on the display.
